(19) United States
(12) Patent Application Publication
(10) Pub. No.: US 2021/0147029 A1
(43) Pub. Date: May 20, 2021

(54) CONTROLLING DEVICE, TRANSMITTING DEVICE, EXTERNAL DEVICE, AND SETTING SYSTEM

(71) Applicant: SHIMANO Inc., Sakai City (JP)

(72) Inventors: Atsushi Komatsu, Sakai City (JP); Tadaharu Kurotobi, Sakai City (JP); Satoshi Idogaki, Sakai City (JP); Shingo Sakurai, Sakai City (JP)

(21) Appl. No.: 17/095,148

(22) Filed: Nov. 11, 2020

(30) Foreign Application Priority Data
Nov. 15, 2019 (JP) 2019-207370

(51) Int. Cl. B62J 45/20; B62M 6/45; B62J 43/13; B62J 43/30; B62H 5/00

(52) U.S. Cl. CPC B62J 45/20; B62M 6/45; B62H 5/00; B62J 43/30; B62J 43/13

(57) ABSTRACT

A controlling device according to the present disclosure includes a communication unit that receives setting information for setting an electric component of a human-powered vehicle to a predetermined setting, and a controller that sets the electric component to the predetermined setting, based on the setting information received by the communication unit. The controller determines whether or not a cancel condition for cancelling the predetermined setting is satisfied.

### TECHNICAL FIELD

The present invention relates to a controlling device, a transmitting device, an external device, and a setting system.

### BACKGROUND

There has been known a human-powered vehicle that includes an electric component. For example, Patent Literature 1 discloses a bicycle including an electric component that assists a human-power driving force by using an electric motor.

### CITATION LIST

### Patent Literature

Patent Literature 1: Patent Application Laid-open No. H05-058379

### SUMMARY OF INVENTION

### Problem to be Solved by the Invention

### Solution to Solve Problem

A controlling device according to a first aspect of the present disclosure includes a first communication unit that receives setting information for setting an electric component of a human-powered vehicle to a predetermined setting, and a first controller that sets the electric component to the predetermined setting, based on the setting information received by the first communication unit, wherein the first controller determines whether or not a cancel condition for cancelling the predetermined setting is satisfied. In accordance with the first aspect, the controlling device is capable of reducing the time and effort required for changing a setting of the electric component and for cancelling the changed setting.

The controlling device of a second aspect according to the first aspect is arranged in a housing of the electric component. In accordance with the second aspect, the controlling device is configured to be integrated with the electric component, so that it is possible to reduce the occurrence of a failure in connection to the electric component.

The controlling device of a third aspect according to the first aspect is arranged in a housing that is separate from the electric component. In accordance with the third aspect, the controlling device is capable of changing and/or cancelling settings of a plurality of electric components.

The controlling device of a fourth aspect according to any one of the first to the third aspects further includes a first storage unit that stores therein a previous setting before setting to the predetermined setting. In accordance with the fourth aspect, the controlling device is capable of storing, in the first storage unit, the previous setting before setting to the predetermined setting.

The first controller of a fifth aspect according to the fourth aspect sets the electric component to the previous setting when determining that the cancel condition is satisfied. In accordance with the fifth aspect, when a cancel condition is satisfied, the controlling device is capable of changing a setting of the electric component from the predetermined setting to the previous setting.

The first controller of a sixth aspect according to the fourth or the fifth aspect is configured to, in response to reception of the setting information by the first communication unit, store, in the first storage unit, identification information of an electric-power supply device connected to the electric component; and in response to connection of an electric-power supply device having identification information different from the identification information stored in the first storage unit to the electric component, cause at least one of a notification device and the electric component to execute an emergency operation. In accordance with the sixth aspect, the controlling device is capable of notifying when the electric-power supply device is replaced with, for example, another different electric-power supply device.

The electric component of a seventh aspect according to any one of the first to the sixth aspects includes at least one of an electric transmission device, an electric braking device, an electric suspension, an electric seat post, and an electric assist device. In accordance with the seventh aspect, the controlling device is capable of reducing the time and effort required for changing a setting of at least one of the electric transmission device, the electric braking device, the electric suspension, the electric seat post, and the electric assist device, and for cancelling the changed setting.

The electric component of an eighth aspect according to the seventh aspect includes at least the electric assist device, and the first controller sets at least one of an output ratio, a steady output, and a maximum output of the electric assist device, based on the setting information. In accordance with the eighth aspect, the controlling device is capable of reducing the time and effort required for changing a setting of the electric assist device and for cancelling the changed setting.

In the predetermined setting of a ninth aspect according to the eighth aspect, a value of at least one of the output ratio, the steady output, and the maximum output of the electric assist device is larger than before setting to the predetermined setting. In accordance with the ninth aspect, the controlling device is capable of changing a travelling performance of the human-powered vehicle by setting the electric component to the predetermined setting.

In the predetermined setting of a tenth aspect according to the eighth aspect, a value of at least one of the output ratio, the steady output, and the maximum output of the electric assist device is smaller than before setting to the predetermined setting. In accordance with the tenth aspect, the controlling device is capable of changing a travelling performance of the human-powered vehicle by setting the electric component to the predetermined setting.

A transmitting device according to an eleventh aspect includes a second storage unit that stores therein setting information for setting an electric component of a human-powered vehicle to a predetermined setting, and a second communication unit that transmits the setting information to a controlling device that is provided on the human-powered vehicle to control the electric component, wherein the second communication unit transmits the setting information to a plurality of controlling devices existing within a predetermined range. In accordance with the eleventh aspect, the transmitting device is capable of reducing the time and effort required for changing a setting of the electric component.

The second communication unit of a twelfth aspect according to the eleventh aspect transmits the setting information to a controlling device having predetermined identification information from among the plurality of controlling devices existing within the predetermined range. In accordance with the twelfth aspect, the transmitting device is capable of reducing the time and effort required for changing a setting of an electric component of the human-powered vehicle in which a specific controlling device having the predetermined identification information is provided.

The transmitting device of a thirteenth aspect according to the eleventh or the twelfth aspect further includes a second controller that determines whether or not a cancel condition for cancelling the predetermined setting is satisfied. In accordance with the thirteenth aspect, the transmitting device is capable of determining, on behalf of the controlling device, whether or not the cancel condition for cancelling the predetermined setting is satisfied.

The second controller of a fourteenth aspect according to the thirteenth aspect controls, when determining that the cancel condition is satisfied, the second communication unit to transmit, to the plurality of controlling devices, cancel information for setting the electric component to a previous setting before setting to the predetermined setting. In accordance with the fourteenth aspect, the transmitting device is capable of reducing the time and effort for cancelling a changed setting of the electric component.

An external device according to a fifteenth aspect includes a third communication unit that communicates with a controlling device that sets, in response to reception of setting information for setting an electric component of a human-powered vehicle to a predetermined setting, the electric component to the predetermined setting, and a third controller that authenticates, when the controlling device sets the electric component to the predetermined setting, the controlling device. In accordance with the fifteenth aspect, the external device is capable of easily determining whether or not an electric component being in communication therewith is set to the predetermined setting.

A setting system according to a sixteenth aspect includes the controlling device according to any one of the first to the tenth aspects and the transmitting device according to any one of the eleventh to the fourteenth aspects. In accordance with the sixteenth aspect, the setting system is capable of reducing the time and effort required for changing a setting of the electric component and for cancelling the changed setting.

The setting system of a seventeenth aspect according to the sixteenth aspect further includes the external device according to the fifteenth aspect. In accordance with the seventeenth aspect, the setting system is capable of easily determining whether or not an electric component being in communication therewith is set to the predetermined setting.

### Effect of the Invention

According to the present disclosure, it is possible to reduce the time and effort required for changing a setting of an electric component and for cancelling the changed setting.

### BRIEF DESCRIPTION OF DRAWINGS

FIG. 1 is a diagram illustrating a human-powered vehicle to which a controlling device is attached.

FIG. 2 is a block diagram illustrating a setting system.

FIG. 3 a sequence diagram illustrating an operation example of the setting system.

FIG. 4 a sequence diagram illustrating an operation example of the setting system.

FIG. 5 is a flowchart illustrating one example of a control flow of the controlling device.

### DESCRIPTION OF EMBODIMENTS

A preferred embodiment of the present invention is described in detail below with reference to the accompanying drawings. The present invention is not limited by the embodiment. When there are multiple embodiments, the present invention includes combinations of the embodiments.

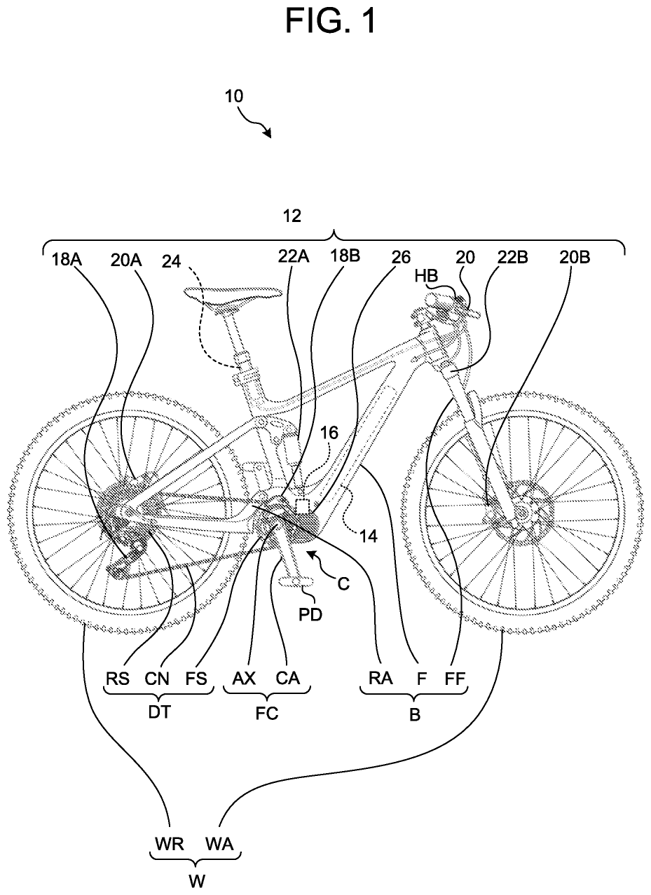

As illustrated in FIG. 1, a human-powered vehicle 10 is a vehicle to be driven at least by human-power driving force. The number of wheels of the human-powered vehicle 10 is not limited thereto, and may be a vehicle having a single wheel alone or equal to or more than three wheels, for example. The human-powered vehicle 10 includes various types of bicycles such as a mountain bicycle, a road bicycle, a city bicycle, a freight bicycle, a recumbent bicycle, and an electric bicycle (E-bike). The electric bicycle includes an electric assist bicycle whose propulsion is assisted by an electric motor. Hereinafter, in an embodiment, the human-powered vehicle 10 will be explained to be an electric assist mountain bicycle.

The human-powered vehicle 10 includes a crank assembly FC into which human-power driving force is input. The human-powered vehicle 10 further includes wheels W and a vehicle body B. The wheels W include a rear wheel WR and a front wheel WA. The vehicle body B includes a frame F, front forks FF, and a rear swing arm RA.

The crank assembly FC includes a crank shaft AX rotatably provided with respect to the frame F, and crank arms CA that are arranged at respective end parts in an axial direction of the crank shaft AX. The crank arms CA are coupled to respective pedals PD. The rear wheel WR is driven by rotation of the crank assembly FC. The rear wheel WR is supported by the frame F. The crank assembly FC and the rear wheel WR are coupled to each other by a drive mechanism DT.

The drive mechanism DT includes a front sprocket assembly FS that is coupled to the crank shaft AX. The crank shaft AX and the front sprocket assembly FS may be coupled to each other by a first one-way clutch. The first one-way clutch is configured such that the front sprocket assembly FS rotates forward if a crank C is rotating forward, and the front sprocket assembly FS does not rotate backward if the crank C is rotating backward. In the present embodiment, the front sprocket assembly FS includes a plurality of front sprockets.

A drive mechanism DT further includes a rear sprocket assembly RS and a chain CN. The chain CN transmits, to the rear sprocket assembly RS, rotational force of the front sprocket assembly FS. The rear sprocket assembly RS is coupled to the rear wheel WR. The rear sprocket assembly RS includes a plurality of rear sprockets. Preferably, a second one-way clutch is arranged between the rear sprocket assembly RS and the rear wheel WR. The second one-way clutch is configured such that a rear wheel WR rotates forward if the rear sprocket assembly RS is rotating forward, and the rear wheel WR does not allowed to rotate backward if the rear sprocket assembly RS is rotating backward.

The front forks FF are rotatably provided to the frame F. A handlebar HB is coupled to the front forks FF via a stem. The front forks FF rotatably support a front wheel WA. The rear swing arm RA is rotatably attached to the frame F. The rear swing arm RA rotatably supports the rear wheel WR.

The human-powered vehicle 10 includes an electric component 12, an electric-power supply device 14, and a controlling device 16. The electric component 12 is connected to the controlling device 16 in a wireless and/or wired manner. The electric component 12 includes at least one of electric transmission devices 18A and 18B, electric braking devices 20A and 20B, electric suspensions 22A and 22B, electric adjustable seat post 24, and an electric assist device 26. In the present embodiment, the electric component 12 includes at least the electric assist device 26.

The electric transmission device 18A is an exterior transmission device that includes an electric motor. For one example, the electric transmission device 18A is configured to change, in response to an input to a rear transmission operating device attached to the handlebar HB, a rear sprocket on which the chain CN is wound in the rear sprocket assembly RS.

The electric transmission device 18B is an exterior transmission device that includes an electric motor. For one example, the electric transmission device 18B is configured to change, in response to an input to a front transmission operating device attached to the handlebar HB, a front sprocket on which the chain CN is wound in the front sprocket assembly FS.

The electric braking device 20A is a disc brake caliper that includes an electric motor. For one example, the electric braking device 20A is configured to grip or release, in response to an input to a rear-brake operating device attached to the handlebar HB, a disc brake rotor that rotates integrally with the rear wheel WR.

The electric braking device 20B is a disc brake caliper that includes an electric motor. For one example, the electric braking device 20B is configured to grip or release, in response to an input to a front-brake operating device attached to the handlebar HB, a disc brake rotor that rotates integrally with the front wheel WA.

The electric suspension 22A is a suspension device that includes an electric motor. The electric suspension 22A is arranged between the frame F and the rear swing arm RA. For one example, the electric suspension 22A is configured to change, in response to an input to a rear-suspension operating device attached to the handlebar HB, at least one of a locked-out state, a travel amount, a damping force, and a repulsion force.

The electric suspension 22B is a suspension device that includes an electric motor. The electric suspension 22B is provided to the front forks FF. For one example, the electric suspension 22B is configured to change, in response to an input to a front-suspension operating device attached to the handlebar HB, at least one of a locked-out state, a travel amount, a damping force, and a repulsion force.

The electric adjustable seat post 24 is a seat post that includes an electric motor. For one example, the electric adjustable seat post 24 is configured to change, in response to an input to an electric-seat-post operating device attached to the handlebar HB, height of a seat of the human-powered vehicle 10.

The electric assist device 26 is a drive unit that includes an electric motor. The electric assist device 26 is configured to output assist driving force in response to human-power driving force input to a crank assembly FC.

The electric-power supply device 14 is a secondary battery that includes a lithium-ion (Li) battery, for example. The electric-power supply device 14 supplies electric power to the electric component 12. For one example, the electric-power supply device 14 is built into a down tube of the frame F.

The controlling device 16 is arranged in a housing of the electric component 12. In the present embodiment, the controlling device 16 is arranged in a housing of the electric assist device 26. The controlling device 16 may be arranged in a housing separated from the housing of the electric component 12. For example, the controlling device 16 may be arranged in a housing of the electric-power supply device 14.

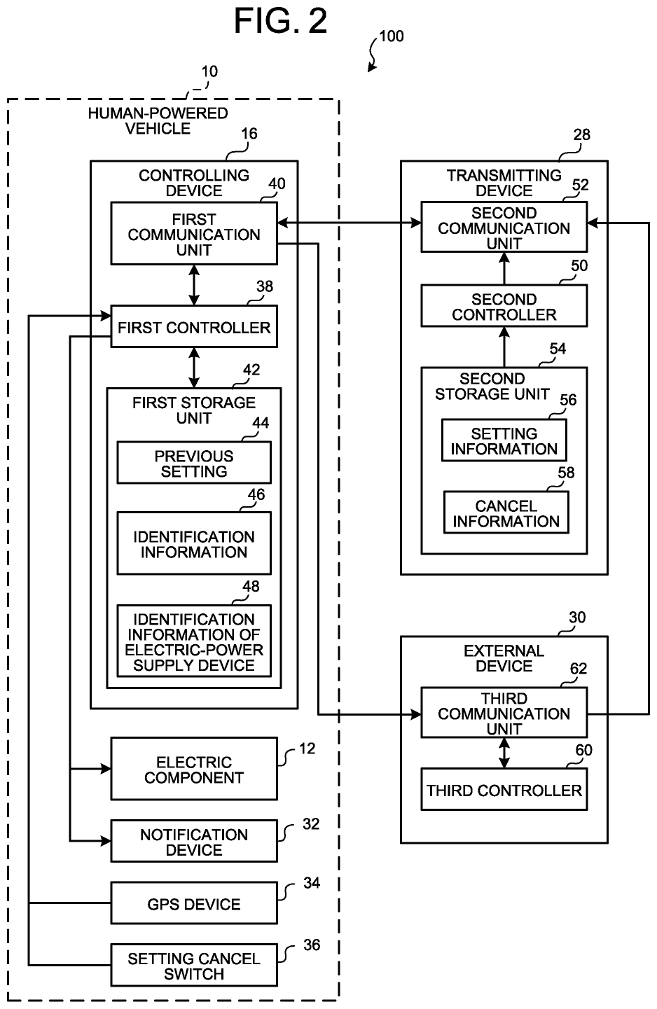

A configuration of a setting system 100 of the electric component 12, which includes the controlling device 16, will be explained with reference to FIG. 2. As illustrated in FIG. 2, the setting system 100 includes the controlling device 16 provided in the human-powered vehicle 10 and a transmitting device 28 provided in a racetrack. The setting system 100 further includes an external device 30.

The transmitting device 28 is a device that is used by an organizer of a race, for example. The transmitting device 28 includes a second controller 50 and a second communication unit 52.

The second controller 50 includes an operation processing device that executes predetermined control programs. The operation processing device includes a Central Processing Unit (CPU) and/or a Micro Processing Unit (MPU), for example. The operation processing device may be arranged at a plurality of positions that are separated from each other. The second controller 50 may include one or more microcomputers. The second communication unit 52 is connected to the controlling device 16 in a wired and/or wireless manner.

The transmitting device 28 includes a second storage unit 54. The second storage unit 54 includes a non-volatile memory and/or a volatile memory, for example. The non-volatile memory includes at least one of a Read-Only Memory (ROM), an Erasable Programmable Read Only Memory (EPROM), an Electrically Erasable Programmable Read-Only Memory (EEPROM), and a flash memory, for example. The volatile memory includes a Random Access Memory (RAM), for example.

The second storage unit 54 stores therein setting information 56. The setting information 56 is information for setting the electric component 12 of the human-powered vehicle 10 to a predetermined setting. The second communication unit 52 transmits the setting information 56 to the controlling device 16 that is provided in the human-powered vehicle 10 so as to control the electric component 12. In the present embodiment, the setting information 56 includes a setting related to at least one of an output ratio, a steady output, and a maximum output of the electric assist device 26. The second storage unit 54 stores therein cancel information 58. The cancel information 58 is information for setting the electric component 12 of the human-powered vehicle 10 to a previous setting 44 before setting to the predetermined setting.

The controlling device 16 includes a first controller 38 and a first communication unit 40. The first controller 38 includes an operation processing device that executes predetermined control programs. The operation processing device includes a Central Processing Unit (CPU) and/or a Micro Processing Unit (MPU), for example. The operation processing device may be arranged at a plurality of positions that are separated from each other. The first controller 38 may include one or more microcomputers. The first communication unit 40 is connected to the transmitting device 28 in a wired and/or wireless manner.

The first communication unit 40 receives the setting information 56 for setting the electric component 12 of the human-powered vehicle 10 to a predetermined setting. On the basis of the setting information 56 received by the first communication unit 40, the first controller 38 sets the electric component 12 to the predetermined setting. Specifically, on the basis of the setting information 56 received by the first communication unit 40, the first controller 38 transmits, to the electric component 12, a control signal for setting the electric component 12 to the predetermined setting.

In the present embodiment, on the basis of the setting information, the first controller 38 sets at least one of an output ratio, a steady output, and a maximum output of the electric assist device 26. It is sufficient that set values of an output ratio, a steady output, and a maximum output of the electric assist device 26 in the predetermined setting are different from those of the previous setting. In other words, in the predetermined setting, at least one of an output ratio, a steady output, and a maximum output of the electric assist device 26 may be larger than that before setting to the predetermined setting, and in the predetermined setting, at least one of an output ratio, a steady output, and a maximum output of the electric assist device 26 may be smaller than that before setting to the predetermined setting.

An output ratio of the electric assist device 26 is a ratio between an amount of human-power driving force and an amount of output of the electric assist device 26. The steady output of the electric assist device 26 is an amount of output of the electric assist device 26 in a state where a traveling velocity of the human-powered vehicle 10 is constant. The maximum output of the electric assist device 26 is an upper limit of output thereof, which is permissible for the electric assist device 26.

The controlling device 16 includes a first storage unit 42. The first storage unit 42 includes a non-volatile memory and/or a volatile memory, for example. The non-volatile memory includes at least one of a Read-Only Memory (ROM), an Erasable Programmable Read Only Memory (EPROM), an Electrically Erasable Programmable Read-Only Memory (EEPROM), and a flash memory, for example. The volatile memory includes a Random access memory (RAM), for example.

The first storage unit 42 stores therein the previous setting 44. The previous setting 44 is a setting of the electric component 12 before a setting is changed to the predetermined setting. In the present embodiment, the previous setting 44 includes at least one of an output ratio, a steady output, and a maximum output of the electric assist device 26 before a setting is changed to the predetermined setting. The first controller 38 stores, in the first storage unit 42, a setting of the electric component 12 before the change to the previous setting 44.

The second controller 50 of the transmitting device 28 determines whether or not a cancel condition for cancelling the predetermined setting of the electric component 12 is satisfied. For example, on the basis of position information of the human-powered vehicle 10 periodically received by the second communication unit 52, if a position of the human-powered vehicle is out of a predetermined range, the second controller 50 determines that the cancel condition is satisfied. Position information of the human-powered vehicle 10 is output from a Global Positioning System (GPS) device 34 that is connected to the controlling device 16 in a wired and/or wireless manner. When determining that the cancel condition is satisfied, the second controller 50 controls the second communication unit 52 so as to transmit, to the plurality of controlling devices 16, the cancel information 58 for setting the electric component 12 to the previous setting 44 before setting to the predetermined setting. The first controller 38 determines whether or not a cancel condition for cancelling the predetermined setting is satisfied. Specifically, on the basis of the cancel information 58 that is transmitted from the transmitting device 28 and is received by the first communication unit 40, the first controller 38 determines that the cancel condition is satisfied.

The first controller 38 may determine that the cancel condition is satisfied when position information output from the GPS device 34 indicates out-of-predetermined range. For example, the predetermined range is a range that is set as a racetrack. For example, the first controller 38 may determine that the cancel condition is satisfied, in response to a cancel signal sent from a setting cancel switch 36 that is connected to the controlling device 16 in a wired and/or wireless manner. If the first controller 38 determines that the cancel condition is satisfied, the electric component 12 is set to the previous setting 44. Specifically, the first controller 38 transmits, to the electric component 12, a control signal for setting to the previous setting 44.

The first storage unit 42 stores therein identification information 46. The identification information 46 includes pieces of identification information specific to the respective human-powered vehicles 10, which are assigned to the plurality of human-powered vehicles 10 by an organizer of a race, for example. The second communication unit 52 transmits the setting information 56 to the plurality of controlling devices 16 existing within a predetermined range. Whether or not the controlling device 16 is existing within the predetermined range is determined on the basis of whether or not the identification information 46 is stored in the first storage unit 42. This is because the controlling device storing therein the identification information 46 that is assigned by an organizer of a race is the controlling device 16 that is present at a racetrack or within a predetermined range that is the vicinity of the racetrack at a time point when the transmitting device 28 transmits the setting information 56 to the human-powered vehicle 10 on which the controlling device 16 is mounted.

Preferably, the second communication unit 52 transmits the setting information 56 to the controlling device 16 having predetermined identification information among the plurality of controlling devices 16 existing within the predetermined range. Specifically, the second communication unit 52 specifies the controlling device 16 having predetermined identification information on the basis of the identification information 46 stored in the first storage units 42 of the plurality of human-powered vehicles 10.

The first storage unit 42 stores therein identification information 48 of the electric-power supply device 14. The identification information 48 of the electric-power supply device 14 includes a piece of identification information specific to each of the electric-power supply devices 14. In response to reception of the setting information 56 by the first communication unit 40, the first controller 38 causes the first storage unit 42 to store therein the identification information 48 of the electric-power supply device 14 connected to the electric component 12.

The controlling device 16 is connected, in a wired and/or wireless manner, to a notification device 32 that executes an emergency operation in response to an instruction transmitted from the controlling device 16. The notification device 32 includes at least one of a buzzer, a light, and a vibration device, for example. In response to connection to the electric component 12 of an electric-power supply device having identification information different from that stored in the first storage unit 42, the first controller 38 causes at least one of the notification device 32 and the electric component 12 to execute an emergency operation. The emergency operation of the notification device 32 includes ringing of a buzzer, blinking of a light, and generating vibration of a vibration device, for example. The emergency operation of the electric component 12 includes a stopping operation of the electric component 12.

The external device 30 is arranged in at least one position having a possibility that the human-powered vehicle 10 will pass through, such as an inspection area arranged in a racetrack, a start gate of a race, and a race course. The external device 30 decides approval or disapproval for passage of the human-powered vehicle 10.

The external device 30 includes a third controller 60 and a third communication unit 62. The third controller 60 includes an operation processing device that executes predetermined control programs. The operation processing device includes a Central Processing Unit (CPU) and/or a Micro Processing Unit (MPU), for example. The operation processing device may be arranged at a plurality of positions that are separated from each other. The third controller 60 may include one or more microcomputers. The third communication unit 62 is connected to the controlling device 16 and the transmitting device 28 in a wired and/or wireless manner.

When the controlling device 16 sets the electric component to a predetermined setting, the third controller 60 authenticates the controlling device 16. For example, if setting information of the electric component 12 which is received by the third communication unit 62 is the predetermined setting, the third controller 60 authenticates the controlling device 16. The external device 30 does not permit passing through of the human-powered vehicle 10 whose controlling device 16 is not authenticated.

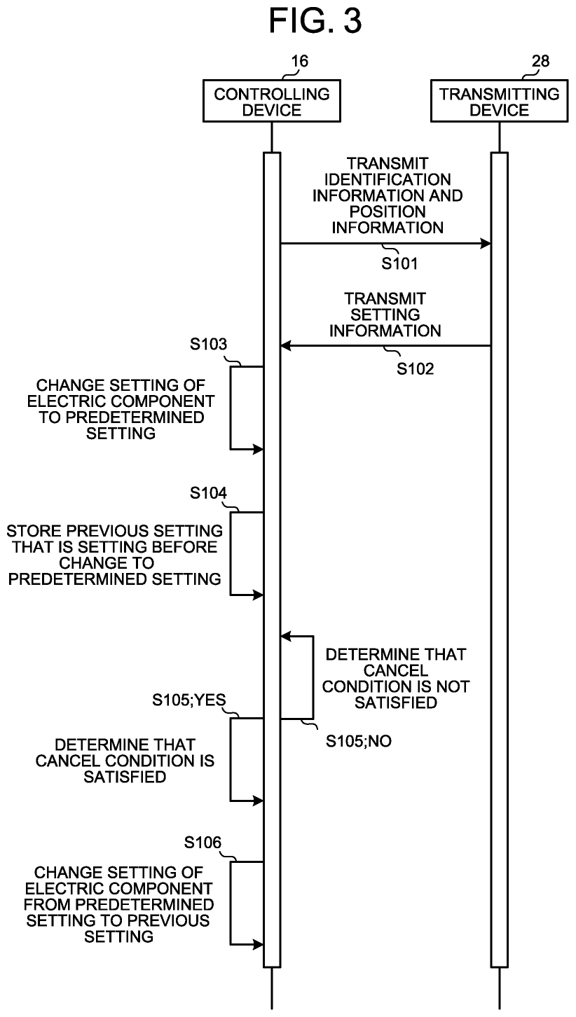

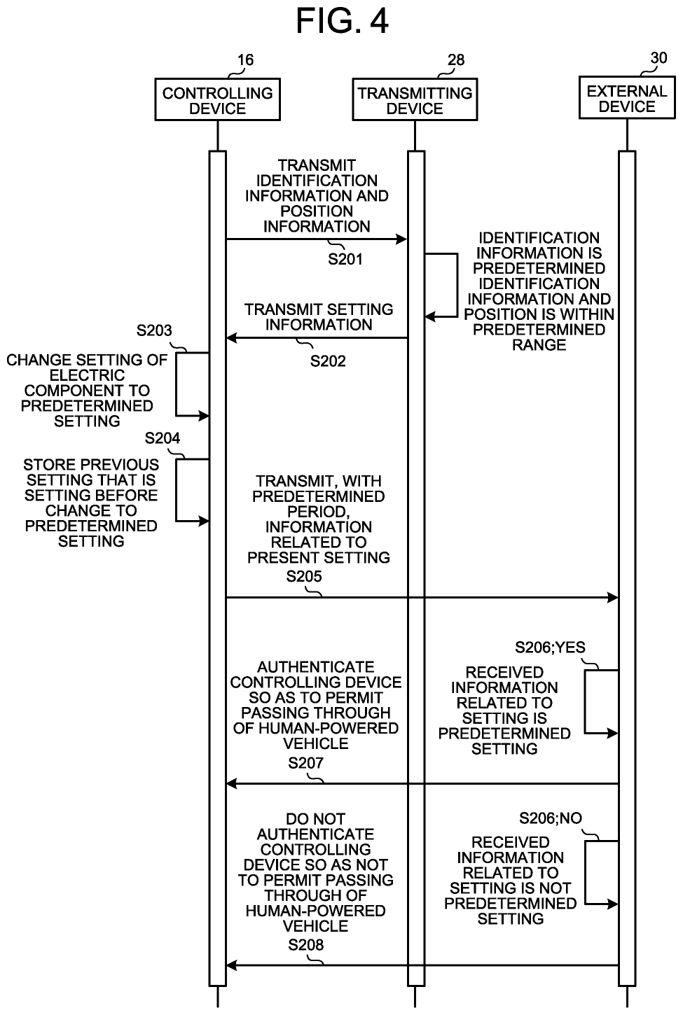

An operation example of the setting system 100 will be explained with reference to FIGS. 3 and 4. FIG. 3 is a diagram illustrating a control flow related to the controlling device 16 and the transmitting device 28. As illustrated in FIG. 3, for example, before a start of a race, the controlling device 16 transmits, to the transmitting device 28, the identification information 46 and position information of the controlling device 16 (Step S101).

If identification information of the controlling device 16 is predetermined identification information and a position of the controlling device 16 is within a predetermined range, the transmitting device 28 transmits the setting information 56 to the controlling device 16 (Step S102). On the basis of the setting information 56 transmitted from the transmitting device 28, the controlling device 16 changes a setting of the electric component 12 to a predetermined setting (Step S103).

The controlling device 16 stores therein the previous setting 44 that is a setting before the change to the predetermined setting (Step S104). Next, the controlling device 16 determines whether or not a cancel condition is satisfied (Step S105). When determining that the cancel condition is not satisfied (Step S105: No), the controlling device executes Step S105 again.

When determining that the cancel condition is satisfied (Step S105: Yes), the controlling device 16 changes a setting of the electric component 12 from the predetermined setting to the previous setting 44 (Step S106).

FIG. 4 is a diagram illustrating a control flow related to the controlling device 16 and the external device 30. As illustrated in FIG. 4, for example, before a start of a race, the controlling device 16 transmits, to the transmitting device 28, the identification information 46 and position information of the controlling device 16 (Step S201). If the identification information of the controlling device 16 is predetermined identification information, and a position of the controlling device 16 is within a predetermined range, the transmitting device 28 transmits the setting information 56 to the controlling device (Step S202). On the basis of the setting information 56 transmitted from the transmitting device 28, the controlling device 16 changes a setting of the electric component 12 to a predetermined setting (Step S203), and stores therein the previous setting 44 before the change to the predetermined setting (Step S204).

The controlling device 16 transmits, with a predetermined period, information related to a present setting to the external device 30 (Step S205). The external device 30 determines whether or not the received information related to setting is the predetermined setting. If the received information related to setting is the predetermined setting (Step S206: Yes), the external device 30 authenticates the controlling device 16 so as to permit passing through of the human-powered vehicle 10 including the authenticated controlling device 16 (Step S207). If the received information related to setting is not the predetermined setting (Step S206: No), the external device 30 does not authenticate the controlling device 16 so as not to permit passing through of the human-powered vehicle 10 including the non-authenticated controlling device 16 (Step S208).

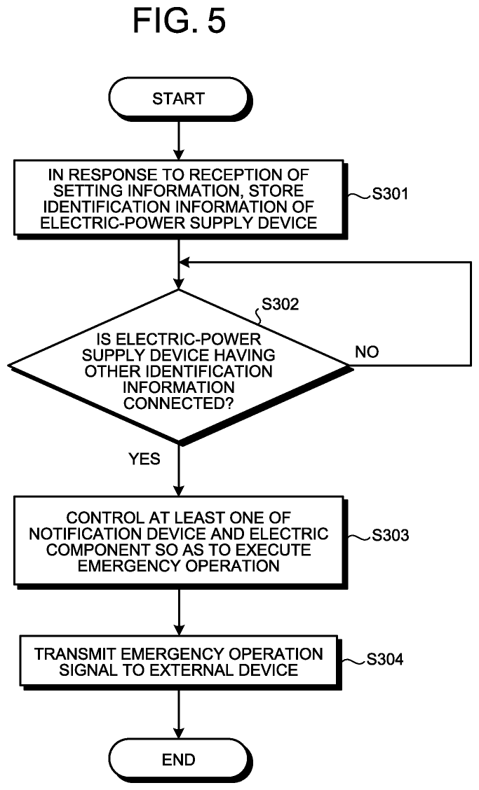

FIG. 5 is a flowchart illustrating a control flow related to an emergency operation in the controlling device 16. In response to reception of the setting information 56 in the first communication unit 40, the first controller 38 stores, in the first storage unit 42, the identification information 48 of the electric-power supply device 14 (Step S301).

Next, the first controller 38 determines whether or not the electric-power supply device 14 having other identification information is connected (Step S302). When determining that the electric-power supply device 14 having other identification information is not connected (Step S302: No), the first controller 38 executes the process of Step S302 again. When determining that the electric-power supply device 14 having other identification information is connected (Step S302: Yes), the first controller 38 controls at least one of the notification device 32 and the electric component 12 so as to execute an emergency operation (Step S303), and transmits an emergency operation signal to the external device 30 (Step S304). When receiving the emergency operation signal, the external device 30 does not permit passing through of the human-powered vehicle 10 including the controlling device 16.

While certain embodiments and modifications of the present invention have been described, the description thereof is not intended to limit the embodiments. The constituting elements described herein include elements easily achieved by one skilled in the art, elements being substantially the same as the constituting elements, and elements within the scope of equivalents of the constituting elements. The constituting elements described herein may be combined in an appropriate manner. Furthermore, various omissions, substitutions and changes in the constituting elements may be made without departing from the spirit of the embodiment.

The phrase “at least one of” as used in this disclosure means “one or more” of a desired choice. For one example, the phrase “at least one of” as used in this disclosure means “only one single choice” or “both choices” if the number of choices is two. For another example, the phrase “at least one of” as used in this disclosure means “only one single choice” or “any combination of equal to or more than two choices” if the number of choices is equal to or more than three.

### EXPLANATIONS OF LETTERS OR NUMERALS

100 Setting system
10 Human-powered vehicle
12 Electric component
14 Electric-power supply device
16 Controlling device
18A, 18B Electric transmission device
20A, 20B Electric braking device
22A, 22B Electric suspension
24 Electric adjustable seat post
26 Electric assist device
28 Transmitting device
30 External device
32 Notification device
38 First controller
40 First communication unit
42 First storage unit
44 Previous setting
46 Identification information
48 Identification information of electric-power supply device
50 Second controller
52 Second communication unit
54 Second storage
56 Setting information
58 Cancel information
60 Third controller
62 Third communication unit

1. A controlling device comprising:
a communication unit that receives setting information for setting an electric component of a human-powered vehicle to a predetermined setting; and
a controller that sets the electric component to the predetermined setting, based on the setting information received by the communication unit, wherein
the controller determines whether or not a cancel condition for cancelling the predetermined setting is satisfied.

2. The controlling device according to claim 1, wherein
the controlling device is arranged in a housing of the electric component.

3. The controlling device according to claim 1, wherein
the controlling device is arranged in a housing that is separate from the electric component.

4. The controlling device according to claim 1, further comprising:
a storage unit that stores therein a previous setting before setting to the predetermined setting.

5. The controlling device according to claim 4, wherein
when determining that the cancel condition is satisfied, the controller sets the electric component to the previous setting.

6. The controlling device according to claim 4, wherein
the controller is configured to:
in response to reception of the setting information by the communication unit, store, in the storage unit, identification information of an electric-power supply device connected to the electric component; and
in response to connection of an electric-power supply device having identification information different from the identification information stored in the storage unit to the electric component, cause at least one of a notification device and the electric component to execute an emergency operation.

7. The controlling device according to claim 1, wherein
the electric component includes at least one of an electric transmission device, an electric braking device, an electric suspension, an electric seat post, and an electric assist device.

8. The controlling device according to claim 7, wherein
the electric component includes at least the electric assist device, and
the controller sets at least one of an output ratio, a steady output, and a maximum output of the electric assist device, based on the setting information.

9. The controlling device according to claim 8, wherein
in the predetermined setting, a value of at least one of the output ratio, the steady output, and the maximum output of the electric assist device is larger than before setting to the predetermined setting.

10. The controlling device according to claim 8, wherein
in the predetermined setting, a value of at least one of the output ratio, the steady output, and the maximum output of the electric assist device is smaller than before setting to the predetermined setting.

11. A transmitting device comprising:
a storage unit that stores therein setting information for setting an electric component of a human-powered vehicle to a predetermined setting; and
a communication unit that transmits the setting information to a controlling device that is provided on the human-powered vehicle to control the electric component, wherein
the communication unit transmits the setting information to a plurality of controlling devices existing within a predetermined range.

12. The transmitting device according to claim 11, wherein
the communication unit transmits the setting information to a controlling device having predetermined identification information from among the plurality of controlling devices existing within the predetermined range.

13. The transmitting device according to claim 11, further comprising:
a controller that determines whether or not a cancel condition for cancelling the predetermined setting is satisfied.

14. The transmitting device according to claim 13, wherein
when determining that the cancel condition is satisfied, the controller controls the communication unit to transmit, to the plurality of controlling devices, cancel information for setting the electric component to a previous setting before setting to the predetermined setting.

15. An external device comprising:
a communication unit that communicates with a controlling device that sets, in response to reception of setting information for setting an electric component of a human-powered vehicle to a predetermined setting, the electric component to the predetermined setting; and
a controller that authenticates, when the controlling device sets the electric component to the predetermined setting, the controlling device.

16. A setting system comprising:
the controlling device according to claim 1; and
a transmitting device, wherein
the controlling device is provided on the human-powered vehicle to control the electric component,
the communication unit is a first communication unit,
the controller is a first controller,
the transmitting device comprises:
a storage unit that stores therein the setting information for setting the electric component of the human-powered vehicle to the predetermined setting;
a second controller; and
a second communication unit that transmits the setting information to the controlling device, and
the second communication unit transmits the setting information to a plurality of controlling devices existing within a predetermined range.

17. The setting system according to claim 16, further comprising:
an external device comprising:
a third communication unit that communicates with the controlling device that sets, in response to reception of the setting information, the electric component to the predetermined setting; and
a third controller that authenticates, when the controlling device sets the electric component to the predetermined setting, the controlling device.
